(19) United States
(12) Patent Application Publication
(10) Pub. No.: US 2026/0046265 A1
(43) Pub. Date: Feb. 12, 2026

(54) CHAT INFORMATION PROCESSING METHOD AND RELATED DEVICE

(71) Applicant: Beijing Zitiao Network Technology Co., Ltd., Beijing (CN)

(72) Inventors: Lingyu WANG, Beijing (CN); Tingsheng SHI, Beijing (CN); Junyi YANG, Beijing (CN); Chen ZHAO, Beijing (CN); Changsheng WANG, Beijing (CN); Liuyuan YU, Beijing (CN); Yijia TIAN, Beijing (CN); Jianfeng LIANG, Beijing (CN); Jinze MAO, Beijing (CN); Qianmin ZHANG, Beijing (CN)

(21) Appl. No.: 19/105,259

(22) PCT Filed: Dec. 8, 2023
(86) PCT No.: PCT/CN2023/137448

§ 371 Date: Feb. 20, 2025

(30) Foreign Application Priority Data
Dec. 23, 2022 (CN) 202211672362.6

(51) Int. Cl. H04L 51/21

(52) U.S. Cl. CPC H04L 51/21

(57) ABSTRACT

Provided in the present disclosure are a chat information processing method and a related device. The method comprises: receiving a first operation for a first chat, wherein the first operation is used for propagating content in the first chat to the outside of the first chat, and the first chat is set as a first-type chat; and for the first operation, executing a second operation that prevents the first operation.

### CROSS-REFERENCE TO RELATED APPLICATIONS

The present application is based on and claims priority to Chinese Patent Application No. 202211672362.6, filed on Dec. 23, 2022, which is incorporated herein by reference in its entirety.

### TECHNICAL FIELD

The present disclosure relates to the field of computer technologies, and in particular, to a chat information processing method and a related device.

### BACKGROUND

Currently, in a multi-user interaction scenario, a user may perform an operation such as copying, forwarding, downloading, screenshotting, or screen recording on message content in a chat, so that messages in the chat can be conveniently shared to the outside of the chat.

However, in some cases, the user expects the message content in the chat to be protected and does not expect the message content in the chat to be spread.

### SUMMARY

In view of this, an objective of the present disclosure is to provide a chat information processing method and a related device.

Based on the above objective, a first aspect of the present disclosure provides a chat information processing method, including:

receiving a first operation for a first chat, where the first operation is used to spread content in the first chat to the outside of the first chat, and the first chat is set as a first type of chat: and
performing, for the first operation, a second operation that prevents the first operation.

In some embodiments, the method further includes:
setting the first chat as the first type of chat in response to receiving a first configuration operation performed on the first chat by a first type of member of the first chat.

In some embodiments, the first configuration operation includes one or more of the following:
an operation of not allowing copying messages;
an operation of not allowing forwarding messages;
an operation of not allowing downloading files;
an operation of not allowing screenshotting; and
an operation of not allowing screen recording.

In some embodiments, the method further includes:
sending, in the first chat, a first system message that is visible to all members in response to receiving the first configuration operation, where the first system message is used to prompt that the first chat is set as the first type of chat.

In some embodiments, the method further includes:
sending, in the first chat, a second system message that is visible only to a new member in response to the new member joining the first chat, where the second system message is used to prompt that the first chat is set as the first type of chat.

In some embodiments, the performing, for the first operation, a second operation that prevents the first operation includes:
responding to the first operation in response to receiving the first operation for the first chat; and
generating a third system message based on operation information of the first operation and information about a member who performs the first operation, and sending the third system message to another member of the first chat.

In some embodiments, the performing, for the first operation, a second operation that prevents the first operation includes:
preventing execution of a first operation instruction for the first operation for the first chat in response to receiving the first operation instruction, where
the first operation instruction is generated by using a shortcut key or third-party software.

In some embodiments, the performing, for the first operation, a second operation that prevents the first operation includes:
blocking or blurring the first chat and executing a second operation instruction for performing the first operation on the first chat in response to receiving the second operation instruction, where
the second operation instruction is generated by using a shortcut key or third-party software.

In some embodiments, the performing, for the first operation, a second operation that prevents the first operation includes:
obtaining a first control that is in the first chat and that is used to perform the first operation, and setting the first control to an inoperable state.

In some embodiments, the method further includes:
displaying first prompt information at a first preset position of the first chat, where the first prompt information is used to prompt that the first operation is inoperable on the first chat, where
the first preset position is adjacent to a position of the first control in the first chat.

In some embodiments, the method further includes: displaying a first message in the first chat in a first list in response to receiving a third operation for the first message; and the performing, for the first operation, a second operation that prevents the first operation includes: obtaining a second control that is in the first list and that is used to perform the first operation on the first message, and setting the second control to an inoperable state.

In some embodiments, the method further includes:
displaying a picture management window in response to receiving a trigger operation for a picture file in the first chat; and
the performing, for the first operation, a second operation that prevents the first operation includes: obtaining a third control that is in the picture management window and that is used to perform the first operation on the picture file, and setting the third control to an inoperable state.

In some embodiments, the method further includes:
setting the first chat as the first type of chat in response to a second configuration operation performed on the first chat by a first type of member of the first chat;
and in the first chat, responding to the first operation in response to receiving the first operation performed on the first chat by the first type of member.

In some embodiments, before the receiving a first operation for a first chat, the method further includes:
displaying a first window above the first chat; and
responding to the first operation for the first window and performing, for the first chat, the second operation that prevents the first operation in response to receiving the first operation for the first window.

In some embodiments, the first operation includes at least one of copying, forwarding, downloading, screenshotting, and screen recording.

A second aspect of the present disclosure provides a chat information processing apparatus, including:
a receiving module, configured to: receive a first operation for a first chat, where the first operation is used to spread content in the first chat to the outside of the first chat, and the first chat is set as a first type of chat; and
an execution module, configured to: perform, for the first operation, a second operation that prevents the first operation.

A third aspect of the present disclosure provides an electronic device, including a memory, a processor, and a computer program stored on the memory and runnable on the processor, where when the processor executes the program, the method according to the first aspect is implemented.

A fourth aspect of the present disclosure provides a non-transitory computer-readable storage medium having stored thereon computer instructions that are used to cause a computer to perform the method according to the first aspect.

A fifth aspect of the present disclosure provides a computer program product, including computer program instructions that, when run on a computer, cause the computer to perform the method according to the first aspect.

### BRIEF DESCRIPTION OF THE DRAWINGS

In order to more clearly describe the technical solutions in the present disclosure or in the related art, the accompanying drawings for describing the embodiments or the related art will be briefly described below. Clearly, the accompanying drawings in the description below show merely the embodiments of the present disclosure, and those of ordinary skill in the art may still derive other accompanying drawings from these accompanying drawings without creative efforts.

FIG. 1 is a schematic flowchart of an exemplary method according to an embodiment of the present disclosure;

FIG. 2 is a schematic diagram of an exemplary system according to an embodiment of the present disclosure;

FIG. 3A is a schematic diagram of an exemplary page according to an embodiment of the present disclosure;

FIG. 3B is a schematic diagram of an exemplary page according to an embodiment of the present disclosure;

FIG. 3C is a schematic diagram of an exemplary page according to an embodiment of the present disclosure;

FIG. 3D is a schematic diagram of an exemplary page according to an embodiment of the present disclosure;

FIG. 3E is a schematic diagram of an exemplary page according to an embodiment of the present disclosure;

FIG. 3F is a schematic diagram of an exemplary page according to an embodiment of the present disclosure;

FIG. 3G is a schematic diagram of an exemplary page according to an embodiment of the present disclosure;

FIG. 3H is a schematic diagram of an exemplary page according to an embodiment of the present disclosure;

FIG. 3I is a schematic diagram of an exemplary page according to an embodiment of the present disclosure;

FIG. 4 is a schematic diagram of an exemplary apparatus according to an embodiment of the present disclosure; and

FIG. 5 is a schematic diagram of a hardware structure of an exemplary computer device according to an embodiment of the present disclosure.

### DETAILED DESCRIPTION

In order to make the objectives, technical solutions, and advantages of the present disclosure clearer, the present disclosure is further described below in detail with reference to specific embodiments and the accompanying drawings.

It should be noted that unless otherwise defined, the technical or scientific terms used in the embodiments of the present disclosure shall have general meanings as understood by those of ordinary skill in the art to which the present disclosure pertains. “First”, “second”, and like words used in the embodiments of the present disclosure do not indicate any order, quantity, or importance, but are merely used to distinguish between different components. “Include” or “comprise” or like words mean that an element or item preceding the term encompasses an element or item or its equivalent listed after the term, without excluding other elements or items. “Connect” or “connected” or like words are not limited to a physical or mechanical connection, but may include an electrical connection, whether direct or indirect. “Up”, “down”, “left”, “right”, and the like are merely used to indicate a relative positional relationship, and the relative positional relationship may change accordingly when an absolute position of the described object changes.

As described in the background art, in a multi-user interaction scenario such as an instant chat, live streaming, or a video conference, a user may send a message in a one-on-one chat or a group chat to enable interaction, and the message may include one or a combination of a plurality of a text message, a picture, a video, and a file.

For the convenience of the user, functions such as copying, forwarding, downloading, screenshotting, and screen recording are usually provided in the above multi-user interaction scenario, to make it convenient for the user to save a message in a one-on-one chat or a group chat locally or share the message to another page or user.

However, in some scenarios, the user expects a message in a chat to be protected, and does not expect message content in the chat to be spread to the outside of the chat.

In view of this, the embodiments of the present disclosure provide a chat information processing method, to protect a chat and prevent a message in the chat from being spread.

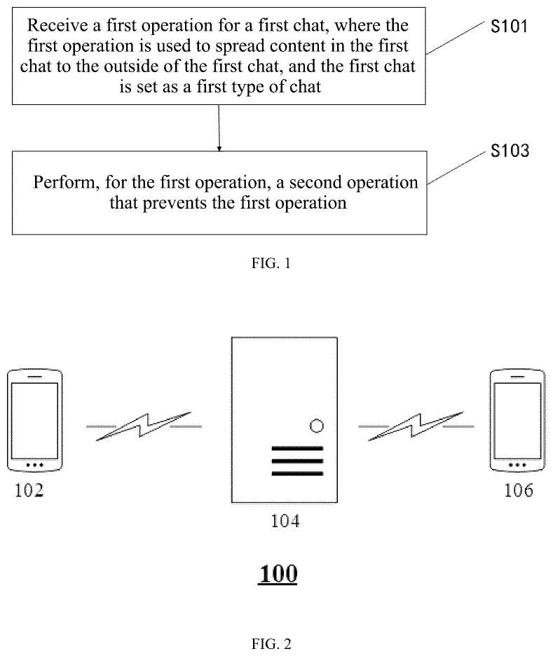

FIG. 1 is a schematic flowchart of an exemplary method according to an embodiment of the present disclosure.

As shown in FIG. 1, an embodiment of the present disclosure provides a chat information processing method, including the following steps.

Step S101: Receive a first operation for a first chat, where the first operation is used to spread content in the first chat to the outside of the first chat, and the first chat is set as a first type of chat.

In this embodiment, the first chat may be a chat associated with a first user account of a user A in a communication system, and a chat interface of the first chat is a chat interface that is of the first chat and that is viewed and used by the user A through the first user account. A messaging group corresponding to the first chat may include another user account of another user in addition to the first user account of the user A, and there may be one or more other user accounts. When there is only one other user account, the messaging group corresponding to the first chat is a one-on-one chat; or when there are a plurality of other user accounts, the messaging group corresponding to the first chat is a group chat.

The first user account and the another user account each may send a message to the messaging group corresponding to the first chat to enable communication between users. When the first user account or the another user account sends a message to the messaging group, the message may be displayed on the chat interface of the first chat, and the user A may view the message on the chat interface of the first chat.

In this embodiment, the first chat may first be set as the first type of chat. The first type of chat is a chat that satisfies a requirement that content in the chat cannot be spread to the outside of the chat. That is, when the first chat is set as the first type of chat, information in the first chat needs to be kept secret, that is, the first chat is set as a secret group.

The first operation may include at least one of copying, forwarding, downloading, screenshotting, and screen recording, and content in the first chat may be spread to the outside of the first chat by copying, forwarding, or downloading a message in the first chat or by performing screenshotting or screen recording on the first chat.

Generally, for one first message, only one of the operations of copying, forwarding, downloading, screenshotting, and screen recording can be performed at the same time. When the first chat includes a text message and an emoji message, an operation such as copying or forwarding may be performed on the text message in the first chat; or when the first chat includes a file, such as a picture file, a video file, or a text file, an operation such as downloading may be performed on the file in the first chat. Furthermore, an operation such as screenshotting or screen recording may be performed on the entire chat interface of the first chat, which is not limited in this embodiment.

When the first operation is performed on the first chat, message content in the first chat may be spread to the outside of the first chat based on the first operation, for example, a message in the first chat may be sent to another chat or system through forwarding, or a message in the first chat may be saved locally and then forwarded to another chat or system through an operation such as copying, downloading, screenshotting, or screen recording, which is not limited in this embodiment.

Step S103: Perform, for the first operation, a second operation that prevents the first operation.

In this embodiment, because the first chat has been set as the first type of chat, when the first operation for the first chat is received, the second operation that prevents the first operation is performed for the first operation, so that the first operation cannot be successfully performed on the first chat, thereby preventing message content in the first chat from being spread to the outside of the first chat, and protecting the message content in the first chat.

In this embodiment, when message content in the first chat needs to be protected, the first chat may be first set as the first type of chat. When the first chat is set as the first type of chat, if a user performs, on the first chat, the first operation for spreading the content in the first chat to the outside of the first chat, the second operation that prevents the first operation is performed, so that the user cannot successfully perform the first operation on the first chat, thereby preventing the message content in the first chat from being spread to the outside of the first chat, and protecting the message content in the first chat.

In some embodiments, the method further includes: setting the first chat as the first type of chat in response to receiving a first configuration operation performed on the first chat by a first type of member of the first chat.

In this embodiment, the first chat may be set as the first type of chat by using a configuration operation performed on the first chat by the first type of member of the first chat. The first type of member of the first chat may be a member having configuration permission in the first chat, for example, the first type of member may be a group owner or a group administrator of the first chat. The group owner or the group administrator of the first chat may implement the first configuration operation through a setting page for the first chat, so that a first configuration operation based on the first configuration operation.

The setting page may be, for example, a group management page through which permission for the first chat may be set, for example, which group member can pin messages and group announcements to top may be set, or which group member can speak in this group may be set.

In the setting page, a setting control for implementing the first configuration operation is included, and the first chat is set as the first type of chat by the first configuration operation that is based on the setting control.

In some embodiments, the first configuration operation includes one or more of an operation of not allowing copying messages, an operation of not allowing forwarding messages, an operation of not allowing downloading files (which may include, for example, a picture file, a video file, or a text file), an operation of not allowing screenshotting, an operation of not allowing screen recording, and the like. The above first configuration operations may be implemented together or may be separately implemented based on needs of members, which is not limited in this embodiment.

In some other embodiments, the first configuration operation may further include: not allowing operations such as copying, forwarding, downloading, screenshotting, and screen recording when a message in the first chat includes preset key content, such as keywords or key information. As such, it may be determined whether the keywords are present in a text message in the first chat: or it may be determined, through semantic recognition or the like, whether the text message in the first chat is semantically the same as the key information: or a picture file, a video file, or a text file in the first chat is recognized through image recognition or the like, to determine whether the keywords are present in recognition result information, or whether the recognition result information is semantically the same as the key information. When the message in the first chat includes these keywords or key information, operations such as copying, forwarding, downloading, screenshotting, and screen recording are not allowed to be performed on the first chat.

In some embodiments, the method further includes: sending, in the first chat, a first system message that is visible to all members in response to receiving the first configuration operation, where the first system message is used to prompt that the first chat is set as the first type of chat.

In this embodiment, when the first chat receives the first configuration operation performed by the user on the first chat, the first chat generates and sends the first system message to the first chat or all the members of the first chat based on the first configuration operation, so that all the members of the first chat know that the first operation is not allowed in the first chat, thereby avoiding misunderstanding of the user. For example, when the group administrator configures the first chat to not allow forwarding messages, the first system message may be “Do not allow forwarding messages in the current group chat”.

In some embodiments, the method further includes: sending, in the first chat, a second system message that is visible only to a new member in response to the new member joining the first chat, where the second system message is used to prompt that the first chat is set as the first type of chat.

In this embodiment, after the first chat is set as the first type of chat, if a new member joins the first chat, the first chat generates and sends the second system message to the new member to avoid misunderstanding of the new member, so as to prompt the new member that the first chat has been set as the first type of chat.

In some embodiments, the performing, for the first operation, a second operation that prevents the first operation in step S103 includes the following steps:

Step S201: Respond to the first operation in response to receiving the first operation for the first chat.

Step S203: Generate a third system message based on operation information of the first operation and information about a member who performs the first operation, and send the third system message to another member of the first chat.

In some scenarios or on some platforms, due to technical limitations or user needs, it is impossible or difficult to not respond to the first operation and generate a response result when the first chat receives the first operation. For example, on a platform such as iOS, operations such as screenshotting and screen recording by the user cannot be prevented. In this case, when the first chat receives the first operation for the first chat, the first chat may respond to the first operation normally. For example, copying or forwarding messages, downloading files, screenshotting, screen recording, or the like may be performed normally, and a response operation result may be generated. In addition, the third system message is generated based on the operation information of the first operation such as screenshotting or screen recording and the information about the member who performs the first operation, and the generated third system message is sent to the another member of the first chat. The another member of the first chat may be only the first type of member, namely, the group owner or the group administrator, of the first chat, or all members except the member who performs the first operation, or a preset designated group member, which is not limited in this embodiment. As such, the information about the member who performs the first operation (such as a group nickname of the member) and the operation information (for example, whether the member has performed screenshotting or screen recording, or message content on which screenshotting or screen recording is performed and a range of the screenshotting or screen recording) may be sent to the another member, to protect a message in the first chat.

In some embodiments, the performing, for the first operation, a second operation that prevents the first operation in step S103 may further include: preventing execution of a first operation instruction for the first operation for the first chat in response to receiving the first operation instruction, where the first operation instruction is generated by using a shortcut key or third-party software.

In the related art, a first operation may be implemented by using a shortcut key or third-party software, for example, an operation such as screenshotting or screen recording for a first chat may be implemented by using a shortcut key, or an operation such as screenshotting or screen recording may be implemented by using third-party software, for example, software having a screenshotting or screen recording function other than software in which the first chat is located, or an operating system platform that provides a screenshotting or screen recording function.

In this case, when a user performs the first operation such as screenshotting or screen recording on the first chat by using a shortcut key or third-party software, a first operation instruction for the first operation is generated and sent to the first chat, and in this case, the first chat performs a second operation that prevents execution of the first operation instruction. That is, in this embodiment, the first operation instruction based on the first operation is intercepted, so that a response cannot be made to the first operation for the first chat, and therefore, an operation result based on the first operation cannot be generated, thereby protecting a first message in the first chat.

In some embodiments, the performing, for the first operation, a second operation that prevents the first operation in step S103 includes: blocking or blurring the first chat and executing a second operation instruction for performing the first operation on the first chat in response to receiving the second operation instruction, where the second operation instruction is generated by using a shortcut key or third-party software.

In this embodiment, when the user performs the first operation such as screenshotting or screen recording on the first chat by using a shortcut key or third-party software, the second operation instruction for the first operation is generated and sent to the first chat. In this embodiment, the first chat is blocked with a preset image or blurred by using a preset method (such as mosaic) before the second operation instruction is executed. In this case, because the first chat has been blocked or blurred when the second operation instruction is executed, even if the second operation instruction is executed to generate an operation result, message content in the first chat is not spread to the outside of the first chat because the first chat in an image obtained through screenshotting or in a video obtained through screen recording has been blocked or blurred, thereby protecting the first message in the first chat.

When the first chat is blocked with the preset image, prompt information such as “The message protection mode is enabled, and group chat content is automatically hidden during screenshotting/screen recording” may be displayed on the preset image, so that the user can conveniently know that this case occurs as the result of message protection, thereby avoiding misunderstanding of the user.

In some embodiments, the performing, for the first operation, a second operation that prevents the first operation in step S103 includes: obtaining a first control that is in the first chat and that is used to perform the first operation, and setting the first control to an inoperable state.

In the related art, there is a first control for implementing the first operation in the first chat, for example, when a mouse hovers over a message or a location for a message is tapped, a control for forwarding the message is displayed; when a message is right-clicked or a location for a message is tapped, a control for copying the message is displayed; when a message is a text file, a control for downloading the file is displayed on a file card displayed in the first chat; and there is a control for implementing screenshotting or screen recording, and the like in an input window of the first chat. In the related art, there are other first controls for implementing the first operation in different interaction scenarios or on different platforms, which is not limited in this embodiment.

In this embodiment, the first control for implementing the first operation may be set to the inoperable state, so that the first operation cannot be performed on the first chat. When the first control is set to the inoperable state, the first control in the inoperable state may still be displayed in the first chat, but the first control does not respond when triggered by clicking or touching, and an icon of the first control may be processed to mark the first control as being in the inoperable state. Alternatively, the first control may be undisplayed directly in the first chat, which is not limited in this embodiment.

In this embodiment, the first control for implementing an operation such as copying, forwarding, downloading, screenshotting, or screen recording may be set to the inoperable state, so that when the user expects to perform the operation such as copying, forwarding, downloading, screenshotting, or screen recording, the above functions cannot be achieved because the first control used for performing the operation is inoperable, thereby preventing message content in the first chat from being spread to the outside of the first chat, and protecting security of the message content in the first chat.

In some embodiments, the method further includes: displaying first prompt information at a first preset position of the first chat, where the first prompt information is used to prompt that the first operation is inoperable on the first chat, where the first preset position is adjacent to a position of the first control in the first chat.

In this embodiment, the first prompt information may be displayed at the first preset position of the first chat while the first control is set to the inoperable state, where the first prompt information is used to prompt that the first operation is inoperable on the first chat. For example, when the first control is a control for implementing a forwarding operation, the first prompt information may be “The message protection mode is enabled, do not allow forwarding messages”. The first prompt information may be displayed synchronously in the first chat when the first control set to the inoperable state is displayed in the first chat; or the first prompt information is displayed when the mouse of the user hovers over the first control set to the inoperable state or when the user attempts to trigger the first control set to the inoperable state, which is not limited in this embodiment.

In this embodiment, the first preset position is adjacent to the position of the first control in the first chat, so that the user can conveniently know that the first prompt information is prompt information for the first control.

In some embodiments, the method further includes: displaying a first message in the first chat in a first list in response to receiving a third operation for the first message; and the performing, for the first operation, a second operation that prevents the first operation in step S103 includes: obtaining a second control that is in the first list and that is used to perform the first operation on the first message, and setting the second control to an inoperable state.

In the related art, when a user performs a third operation on a first message in a first chat, and displays, in a first list, the first message obtained after the third operation is performed, a second control for performing the first operation is still set in the first list. For example, the third operation may be an operation such as adding to favorites, and the first list may be a favorites list. When the user adds the first message in the first chat to favorites, the first message added to favorites may be displayed in the favorites list, and a control for forwarding the first message is still set in the favorites list. In this embodiment, to prevent a message in the first chat from being spread to the outside of the first chat, the second control in the favorites list may also be set to an inoperable state, so that message content in the first chat cannot be spread to the outside of the first chat even if the second control is in the first list, thereby protecting security of the message content in the first chat.

In some embodiments, the method further includes: displaying a picture management window in response to receiving a trigger operation for a picture file in the first chat; and the performing, for the first operation, a second operation that prevents the first operation in step S103 includes: obtaining a third control that is in the picture management window and that is used to perform the first operation on the picture file, and setting the third control to an inoperable state.

In the related art, when a picture file such as a picture file sent to the first chat through a message, or a picture file included in a card message is present in the first chat, a picture management window may be displayed in the first chat when the user triggers the picture file, and the picture management window is used for implementing a management operation, for example, zooming in for viewing, zooming out for viewing. downloading, or editing, on the picture file.

A third control, for example, a download control for performing a download operation, for performing the first operation is still set in the picture management window. In this embodiment, to prevent a picture file in the first chat from being spread to the outside of the first chat, the third control in the picture management window may also be set to an inoperable state, so that message content in the first chat cannot be spread to the outside of the first chat even through the picture management window, thereby protecting security of the message content in the first chat.

In some embodiments, the method further includes: setting the first chat as the first type of chat in response to a second configuration operation performed on the first chat by a first type of member of the first chat: and in the first chat, responding to the first operation in response to receiving the first operation performed on the first chat by the first type of member.

In some cases, it is necessary to prohibit the another member of the first chat from spreading message content in the first chat, but in special cases, some members of the first chat, including the first type of member such as the group owner or the group administrator, need to perform the first operation such as copying messages, forwarding messages, downloading files, screenshotting, or screen recording on the first chat. In this case, while the first type of member such as the group owner or the group administrator sets the first chat as the first type of chat, the first type of member such as the group owner or the group administrator may be set to be not affected by the configuration operation. That is, when the first type of member such as the group owner or the group administrator performs the first operation on the first chat, the first chat responds to the first operation and generates an operation result.

In some embodiments, before the receiving a first operation for a first chat, the method further includes: displaying a first window above the first chat; and responding to the first operation for the first window and performing, for the first chat, the second operation that prevents the first operation in response to receiving the first operation for the first window.

In some embodiment, the first window is displayed above the first chat, the first window may be a window of third-party software, and at least a part of the first chat is not blocked by the first window. In this case, if the user performs the first operation such as screenshotting or screen recording on the first window; to avoid performing screenshotting or screen recording on message content in the first chat, the second operation that prevents the first operation may be performed on the first chat, for example, the first chat may be blocked or blurred. As such, security of message content in the first chat is protected without affecting a normal screenshotting or screen recording operation performed on another window by the user.

FIG. 2 is a schematic diagram of an exemplary system 100 according to an embodiment of the present disclosure.

As shown in FIG. 2, the system 100 may include a first terminal 102, a server 104, and a second terminal 106. The first terminal 102 and the second terminal 106 are only used to distinguish between different electronic devices, and do not represent a quantity of electronic devices in an application scenario. In an actual application, there may be a plurality of electronic devices. The first terminal 102 or the second terminal 106 includes but is not limited to a desktop computer, a mobile phone, a mobile computer, a tablet computer, a media player, a smart wearable device, a personal digital assistant (PDA), or another electronic device capable of achieving the above functions.

In some embodiments, the system 100 may be applied to a multi-user interaction scenario, which may be, for example, an instant chat scenario, a live streaming scenario, or a video conference scenario. Taking an instant messaging chat scenario as an example, the server 104 is configured to provide an instant chat service. The first terminal 102/the second terminal 106 is a terminal corresponding to a user who chats in the instant messaging chat scenario, and has a client for communicating with the second terminal 106/the first terminal 102 installed thereon. A user can enter a multi-user interaction scenario such as a multi-user chat scenario via the client.

In some embodiments, when the system 100 is applied to a one-on-one chat scenario, there is one first terminal 102 and one second terminal 106. When the system 100 is applied to a group chat scenario, there may be a plurality of second terminals 106.

The server 104 may be a single server or a plurality of servers. In a scenario of a plurality of servers, these servers may use a distributed architecture and form a server cluster.

The first terminal 102 and the second terminal 106 each may be any terminal device, such as a mobile terminal (e.g., a mobile phone or a tablet computer (Pad)), or a fixed terminal (e.g., a personal computer (PC) or a notebook computer). The first terminal 102 and the second terminal 106 may run applications and provide users with corresponding services such as a chat service via the applications.

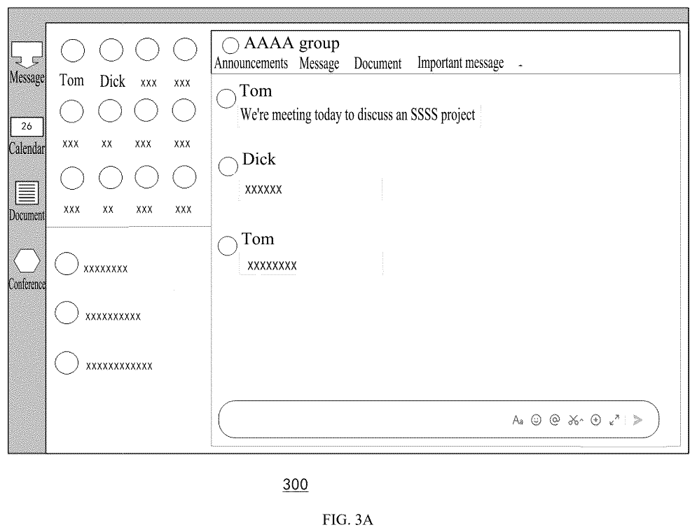

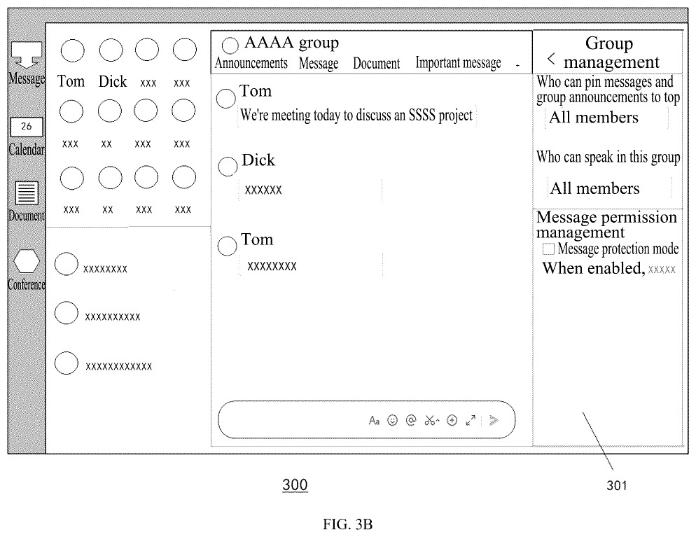

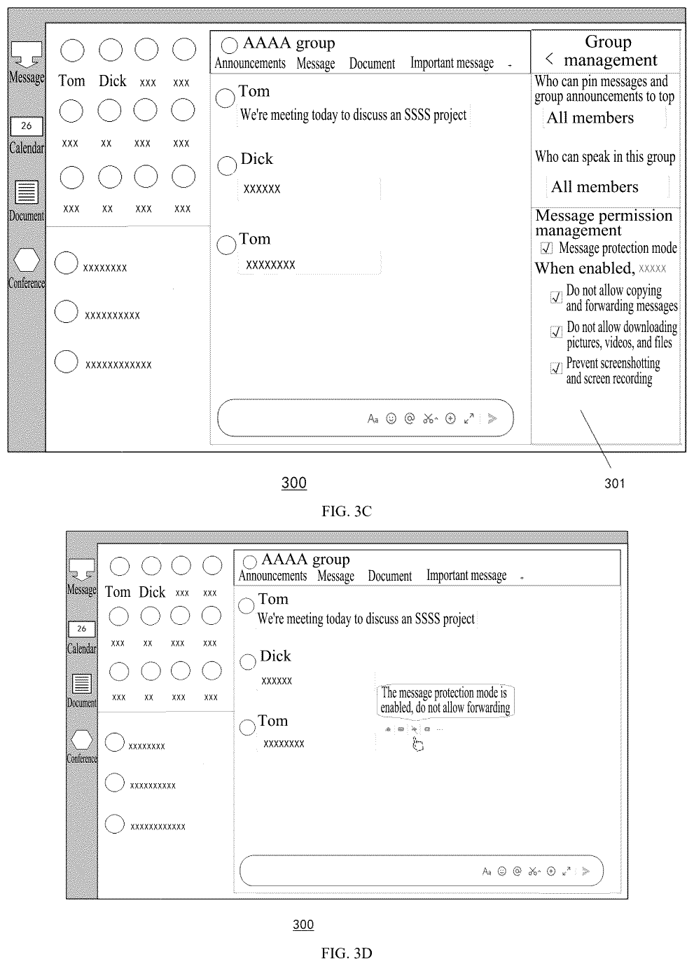

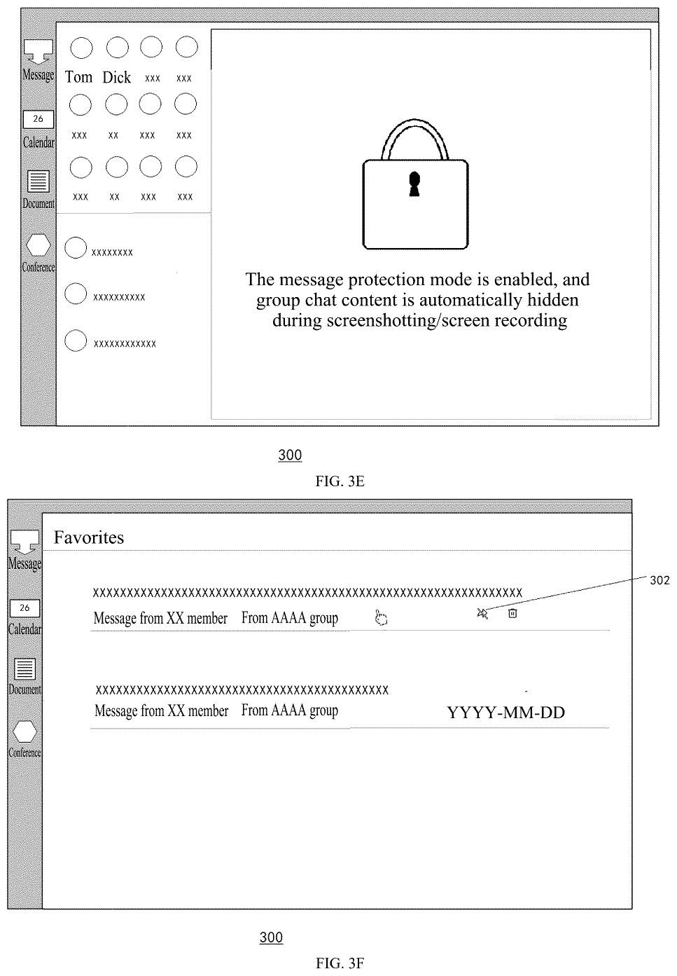

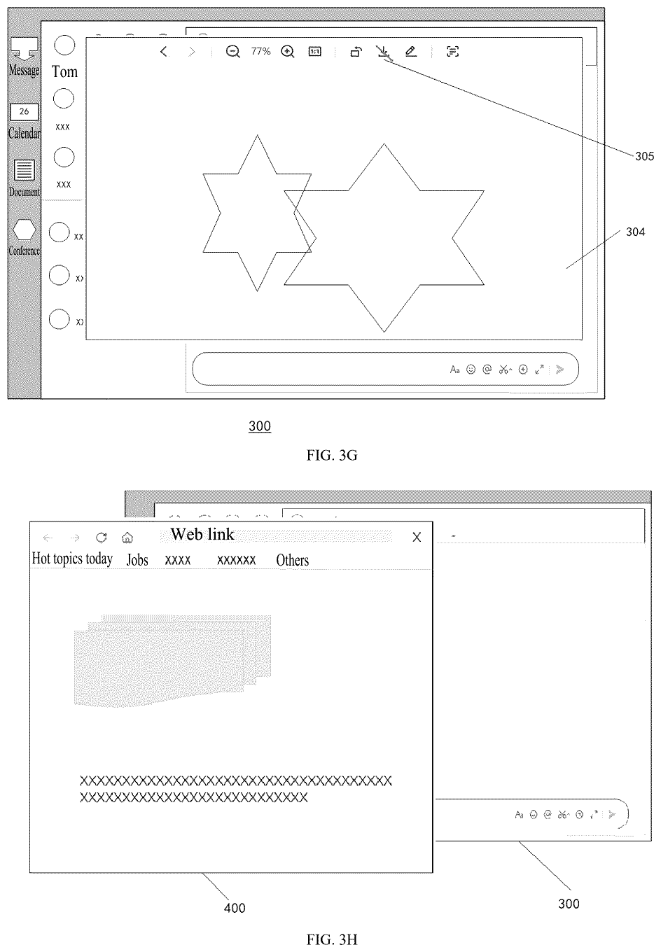

FIG. 3A is a schematic diagram of an exemplary page 300 according to an embodiment of the present disclosure.

As shown in FIG. 3A, the exemplary page 300 includes a chat interface of a first chat. In a multi-user interaction scenario, such as an instant messaging chat scenario, a user may send a message in a messaging group corresponding to the first chat. The message is displayed in the chat interface of the first chat, and the user who sends the message and another user in the messaging group may view the message.

The chat interface of the first chat includes a system setting control, and when a terminal receives a trigger operation performed on the system setting control by a first type of member such as a group owner or a group administrator of the first chat, a setting page for the first chat is displayed.

As shown in FIG. 3B, a setting page 301 may be a group management page for the first chat, and which group member can pin messages and group announcements to top, which group member can speak in this group, and the like may be set through the group management page. The setting page 301 further includes a setting control for implementing a first configuration operation, and the first chat may be set as a first type of chat through the first configuration operation based on the setting control. When the first chat is a first type of chat, message content in the first chat can be protected.

As shown in FIG. 3C, one or more of an operation of not allowing copying messages, an operation of not allowing forwarding messages, an operation of not allowing downloading files (which may include, for example, picture files, video files, or text files), an operation of not allowing screenshotting, or an operation of not allowing screen recording may be set based on the first configuration operation. For example, whether to enable “Don't allow copying and forwarding messages such as text information, pictures, videos, and files”, “Don't allow downloading messages such as pictures, videos, and files”, “Prevent screenshotting and screen recording”, or the like can be set separately, so that different settings can be made for a protection mode of the first chat, thereby satisfying different message protection needs of different chats.

In some embodiments, only a first type of member (e.g., a group owner or a group administrator) having preset permission among members of the first chat can set message protection content.

When the first chat receives the first configuration operation performed by a user on the first chat, the first chat generates and sends a first system message that is visible to all the members based on the first configuration operation, so that the first system message can be sent to the first chat or all the members of the first chat. In this way, all the members of the first chat know that a first operation is not allowed in the first chat, so that misunderstanding of the user is avoided. For example, when the group administrator configures the first chat as not allowing forwarding messages, the first system message may be “Do not allow forwarding messages in the current group chat”.

After the first chat is set as the first type of chat, if a new member joins the first chat, the first chat generates a second system message that is visible only to the new member and sends it to the new member to avoid misunderstanding of the new member, so as to prompt the new member that the first chat has been set as the first type of chat.

In some embodiments, while the first type of member such as the group owner or the group administrator sets the first chat as the first type of chat, the first type of member such as the group owner or the group administrator may be set to be not affected by the configuration operation. That is, when the first type of member such as the group owner or the group administrator performs the first operation on the first chat, the first chat responds to the first operation and generates an operation result.

As such, after the first chat is set as the first type of chat, when the first operation for the first chat that is used to spread message content in the first chat to the outside of the first chat is received, a second operation that prevents the first operation is performed for the first operation, so that the first operation cannot be successfully performed on the first chat, thereby preventing the message content in the first chat from being spread to the outside of the first chat, and protecting the message content in the first chat.

In some embodiments, the performing, for the first operation, a second operation that prevents the first operation may be: responding to the first operation in response to receiving the first operation for the first chat: and generating a third system message based on operation information of the first operation and information about a member who performs the first operation, and sending the third system message to another member of the first chat. That is, in this embodiment, when the first chat receives the first operation, the first chat may respond to the first operation normally. For example, copying or forwarding messages, downloading files, screenshotting, screen recording, or the like may be performed normally, and a response operation result may be generated. In addition, the third system message is generated based on the operation information of the first operation such as screenshotting or screen recording and the information about the member who performs the first operation, and the generated third system message is sent to the another member of the first chat to protect messages in the first chat.

In some embodiments, the performing, for the first operation, a second operation that prevents the first operation may be: preventing execution of a first operation instruction for the first operation for the first chat in response to receiving the first operation instruction, where the first operation instruction is generated by using a shortcut key or third-party software. In this embodiment, when the user performs the first operation such as screenshotting or screen recording on the first chat by using a shortcut key or third-party software, the first operation instruction for the first operation is generated and sent to the first chat, and in this case, the first chat performs the second operation that prevents execution of the first operation instruction. That is, in this embodiment, the first operation instruction based on the first operation is intercepted, so that a response cannot be made to the first operation for the first chat, and therefore, an operation result based on the first operation cannot be generated, thereby protecting a first message in the first chat.

In some embodiments, the performing, for the first operation, a second operation that prevents the first operation may be: blocking or blurring the first chat and executing a second operation instruction for performing the first operation on the first chat in response to receiving the second operation instruction, where the second operation instruction is generated by using a shortcut key or third-party software. In this embodiment, when the user performs the first operation such as screenshotting or screen recording on the first chat by using a shortcut key or third-party software, the second operation instruction for the first operation is generated and sent to the first chat. As shown in FIG. 3E, in this embodiment, the first chat is blocked with a preset image or blurred using a preset method (such as mosaic) before the second operation instruction is executed. In this case, because the first chat has been blocked or blurred before the second operation instruction is executed, even if the second operation instruction is executed to generate an operation result, message content in the first chat is not spread to the outside of the first chat because the first chat in an image obtained through screenshotting or in a video obtained through screen recording has been blocked or blurred, thereby protecting the first message in the first chat.

As shown in FIG. 3E, when the first chat is blocked with the preset image, prompt information such as “The message protection mode is enabled, and group chat content is automatically hidden during screenshotting/screen recording” may be displayed on the preset image, so that the user can conveniently know that this case occurs as the result of message protection, thereby avoiding misunderstanding of the user.

In some embodiments, the performing, for the first operation, a second operation that prevents the first operation may be: obtaining a first control that is in the first chat and that is used to perform the first operation, and setting the first control to an inoperable state. In this embodiment, there is a first control that is in the first chat and that is used to implement the first operation. For example, as shown in FIG. 3D, there is a control for forwarding the message in the first chat. In this embodiment, the first control for implementing an operation such as copying, forwarding, downloading, screenshotting, or screen recording may be set to the inoperable state, so that when the user expects to perform the operation such as copying, forwarding, downloading, screenshotting, or screen recording, the above functions cannot be achieved because the first control used for performing the operation is inoperable, thereby preventing the message content in the first chat from being spread to the outside of the first chat, and protecting security of the message content in the first chat.

Actually, while the first control is set to the inoperable state, first prompt information may also be displayed at a first preset position of the first chat, where the first prompt information is used to prompt that the first operation is inoperable on the first chat. As shown in FIG. 3D, for example, when the first control is a control for implementing a forwarding operation, the first prompt information may be “The message protection mode is enabled, and forwarding messages is not allowed”. The first preset position is adjacent to a position of the first control in the first chat, so that the user can conveniently know that the first prompt information is prompt information for the first control.

In some embodiments, when the user performs a third operation, such as adding to favorites, on a first message in the first chat, the first message added to favorites may be displayed in a favorites list, and a second control for performing the first operation is still set in the favorites list. In this embodiment, as shown in FIG. 3F, to prevent a message in the first chat from being spread to the outside of the first chat, a second control 302 in the favorites list may also be set to an inoperable state, so that the message content in the first chat cannot be spread to the outside of the first chat even if the second control is in the first list, thereby protecting security of the message content in the first chat.

In some embodiments, as shown in FIG. 3G, when a picture file is present in the first chat, a picture management window 304 may be displayed in the first chat when the user triggers the picture file. A third control 305 for performing the first operation, such as a download control for performing a download operation, is still set in the picture management window 304. In this embodiment, to prevent a picture file in the first chat from being spread to the outside of the first chat, the third control 305 in the picture management window 304 may also be set to an inoperable state, so that message content in the first chat cannot be spread to the outside of the first chat even through the picture management window 304, thereby protecting security of the message content in the first chat.

In some embodiments, as shown in FIG. 3H, a first window 400 is displayed above the first chat, the first window 400 may be a window of third-party software, and at least a part of the first chat is not blocked by the first window 400. In this case, if the user performs the first operation such as screenshotting or screen recording on the first window 400, screenshotting or screen recording may be performed on the message content in the first chat. Therefore, as shown in FIG. 3I, in this embodiment, when the first operation for the first window 400 is received, a response is made to the first operation for the first window 400, and the second operation that prevents the first operation is performed for the first chat, for example, the first chat may be blocked or blurred. As such, security of the message content in the first chat is protected without affecting a normal screenshotting or screen recording operation performed on another window by the user.

It should be noted that the method in the embodiments of the present disclosure may be performed by a single device, such as a computer or a server. The method in the embodiments may also be applied to a distributed scenario to be completed through cooperation of a plurality of devices. In the distributed scenario, one of the plurality of devices may only perform one or more steps of the method in the embodiments of the present disclosure. The plurality of devices interact with each other to complete the method.

It should be noted that some embodiments of the present disclosure are described above. Other embodiments are within the scope of the appended claims. In some cases, the actions or steps recited in the claims can be performed in an order different from that in the above embodiments, and can still achieve desired results. In addition, the processes depicted in the accompanying drawings are not necessarily required to be shown in a particular or sequential order, to achieve desired results. In some implementations, multi-task processing and parallel processing are also possible or may be advantageous.

Based on the same inventive concept, corresponding to the method in any one of the above embodiments, the present disclosure further provides a message processing apparatus.

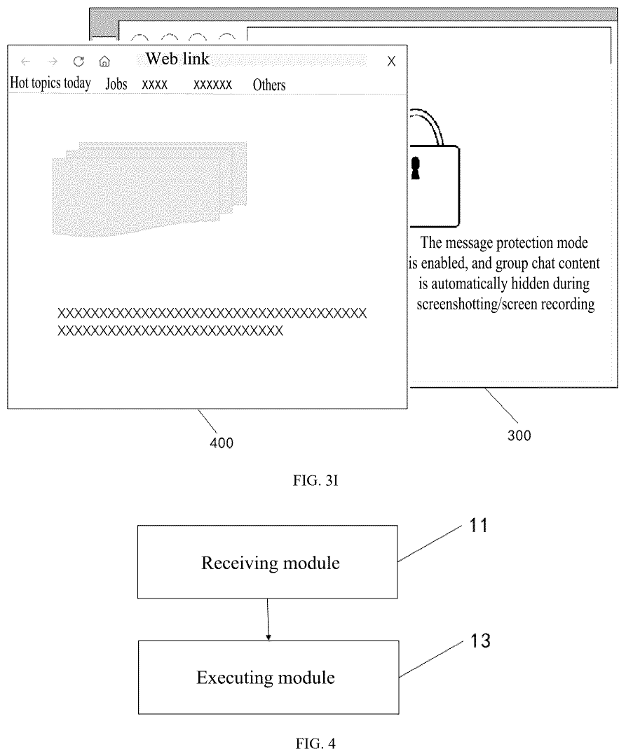

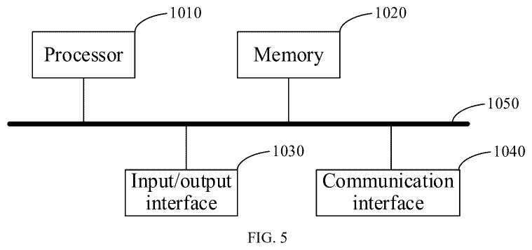

Referring to FIG. 4, the apparatus includes:
a receiving module 11, configured to: receive a first operation for a first chat, where the first operation is used to spread content in the first chat to the outside of the first chat, and the first chat is set as a first type of chat; and
an execution module 13, configured to: perform, for the first operation, a second operation that prevents the first operation.

In some embodiments, the apparatus is further configured to: set the first chat as the first type of chat in response to receiving a first configuration operation performed on the first chat by a first type of member of the first chat.

In some embodiments, the first configuration operation includes one or more of the following:
an operation of not allowing copying messages;
an operation of not allowing forwarding messages;
an operation of not allowing downloading files;
an operation of not allowing screenshotting; and
an operation of not allowing screen recording.

In some embodiments, the apparatus is further configured to: send, in the first chat, a first system message that is visible to all members in response to receiving the first configuration operation, where the first system message is used to prompt that the first chat is set as the first type of chat.

In some embodiments, the apparatus is further configured to: send, in the first chat, a second system message that is visible only to a new member in response to the new member joining the first chat, where the second system message is used to prompt that the first chat is set as the first type of chat.

In some embodiments, the execution module 13 is further configured to:
respond to the first operation in response to receiving the first operation for the first chat; and
generate a third system message based on operation information of the first operation and information about a member who performs the first operation, and send the third system message to another member of the first chat.

In some embodiments, the execution module 13 is further configured to:
prevent execution of a first operation instruction for the first operation for the first chat in response to receiving the first operation instruction, where
the first operation instruction is generated by using a shortcut key or third-party software.

In some embodiments, the execution module 13 is further configured to:
block or blur the first chat and execute a second operation instruction for performing the first operation on the first chat in response to receiving the second operation instruction, where
the second operation instruction is generated by using a shortcut key or third-party software.

In some embodiments, the execution module 13 is further configured to: obtain a first control that is in the first chat and that is used to perform the first operation, and set the first control to an inoperable state.

In some embodiments, the apparatus is further configured to:
display first prompt information at a first preset position of the first chat, where the first prompt information is used to prompt that the first operation is inoperable on the first chat, where
the first preset position is adjacent to a position of the first control in the first chat.

In some embodiments, the apparatus is further configured to: display a first message in the first chat in a first list in response to receiving a third operation for the first message.

The execution module 13 is further configured to: obtain a second control that is in the first list and that is used to perform the first operation on the first message, and set the second control to an inoperable state.

In some embodiments, the apparatus is further configured to:
display a picture management window in response to receiving a trigger operation for a picture file in the first chat; and
the performing, for the first operation, a second operation that prevents the first operation includes: obtaining a third control that is in the picture management window and that is used to perform the first operation on the picture file, and setting the third control to an inoperable state.

In some embodiments, the apparatus is further configured to:
set the first chat as the first type of chat in response to a second configuration operation performed on the first chat by a first type of member of the first chat;
and in the first chat, respond to the first operation in response to receiving the first operation performed on the first chat by the first type of member.

In some embodiments, before the receiving a first operation for a first chat, the apparatus is further configured to:
display a first window above the first chat; and
respond to the first operation for the first window and perform, for the first chat, the second operation that prevents the first operation in response to receiving the first operation for the first window.

In some embodiments, the first operation includes at least one of copying, forwarding, downloading, screenshotting, and screen recording.

For ease of description, when described, the above apparatus is divided into various modules based on functions. Certainly, functions of the modules may be implemented in one or more pieces of software and/or hardware when the present disclosure is implemented.

The apparatus in the above embodiments is configured to implement the corresponding method in any one of the above embodiments, and has the beneficial effects of the corresponding method embodiment, which are not repeated herein.

Based on the same inventive concept, corresponding to the method in any one of the above embodiments, the present disclosure further provides an electronic device, including a memory, a processor, and a computer program stored on the memory and runnable on the processor, where when the processor executes the program, the method in any one of the above embodiments is implemented.

FIG. 5 is a schematic diagram of a more specific hardware structure of an electronic device according to an embodiment. The device may include: a processor 1010, a memory 1020, an input/output interface 1030, a communication interface 1040, and a bus 1050. The processor 1010, the memory 1020, the input/output interface 1030, and the communication interface 1040 are communicatively connected to each other within the device through the bus 1050.

The processor 1010 may be implemented using a general-purpose central processing unit (CPU), a microprocessor, an application specific integrated circuit (ASIC), or one or more integrated circuits, etc. for executing related programs, to implement the technical solutions provided in the embodiments of the specification.

The memory 1020 may be implemented using a read only memory (ROM), a random access memory (RAM), a static storage device, a dynamic storage device, etc. The memory 1020 may store an operating system and other applications, and when the technical solutions provided in the embodiments of the specification are implemented by means of software or firmware, related program code is stored in the memory 1020 and called by the processor 1010 for execution.

The input/output interface 1030 is configured to connect to an input/output module to enable information input and output. The input/output module may be configured as a component in the device (not shown), or may be external to the device to provide a corresponding function. The input device may include a keyboard, a mouse, a touch screen, a microphone, various sensors, etc., and the output device may include a display, a speaker, a vibrator, an indicator light, etc.

The communication interface 1040 is configured to connect to a communication module (not shown) to enable communication interaction between the device and other devices. The communication module may communicate in a wired (e.g., a USB and a network cable) manner, or in a wireless (e.g., a mobile network, Wi-Fi, and Bluetooth) manner.

The bus 1050 includes a path for transferring information between the components (for example, the processor 1010, the memory 1020, the input/output interface 1030, and the communication interface 1040) of the device.

It should be noted that although only the processor 1010, the memory 1020, the input/output interface 1030, the communication interface 1040, and the bus 1050 are shown in the device, during a specific implementation, the device may further include other components necessary for proper operation. Furthermore, it can be understood by those skilled in the art that the device may include only the components necessary to implement the solutions provided in the embodiments of the specification, and not necessarily include all of the components shown in the figure.

The electronic device in the above embodiment is configured to implement the corresponding method in any one of the above embodiments, and has the beneficial effects of the corresponding method embodiment, which are not repeated herein.

It can be learned from the above descriptions that in the chat information processing method and the related device provided in the present disclosure, when message content in a first chat needs to be protected, the first chat may be first set as a first type of chat. When the first chat is set as the first type of chat, if a user performs, on the first chat, a first operation for spreading content in the first chat to the outside of the first chat, a second operation that prevents the first operation is performed, so that the user cannot successfully perform the first operation on the first chat, thereby preventing the message content in the first chat from being spread to the outside of the first chat, and protecting the message content in the first chat.

Based on the same inventive concept, corresponding to the method in any one of the above embodiments, the present disclosure further provides a non-transitory computer-readable storage medium having stored thereon computer instructions that are used to cause a computer to perform the method in any one of the above embodiments.

The computer-readable medium in this embodiment includes permanent and non-permanent, removable and non-removable media, and may implement information storage by using any method or technology. Information may be computer-readable instructions, data structures, modules of a program, or other data. Examples of the computer storage medium include but are not limited to a phase-change random access memory (PRAM), a static random access memory (SRAM), a dynamic random access memory (DRAM), another type of random access memory (RAM), a read-only memory (ROM), an electrically erasable programmable read only memory (EEPROM), a flash memory or other memory technologies, a compact disc read-only memory (CD-ROM), a digital versatile disc (DVD) or other optical storage, a magnetic cassette tape, magnetic tape disk storage or other magnetic storage devices or any other non-transmission media that can be used to store information that can be accessed by a computing device.

The computer instructions stored on the storage medium in the above embodiment are used to cause the computer to perform the method in any one of the above embodiments, and have the beneficial effects of the corresponding method embodiment, which are not repeated herein.

Based on the same inventive concept, corresponding to the method in any one of the above embodiments, the present disclosure further provides a computer program product including a computer program. In some embodiments, the computer program may be executed by one or more processors to cause the processor to perform the method in the above embodiment.

The computer program product in the above embodiment is used to cause the processor to perform the method in any one of the above embodiments, and has the beneficial effects of the corresponding method embodiment, which are not repeated herein.

It should be understood by those of ordinary skill in the art that the discussion of any one of the above embodiments is merely exemplary, and is not intended to imply that the scope of the present disclosure (including the claims) is limited to these examples: and with the concept of the present disclosure, the technical features in the above embodiments or different embodiments may also be combined, steps may be implemented in any order, and many other changes may be made to different aspects of the embodiments of the present disclosure as described above and are not provided in detail for simplicity.

In addition, to simplify description and discussion and avoid obscuring an understanding of the embodiments of the present disclosure, well-known power/ground connections to an integrated circuit (IC) chip and other components may or may not be shown in the accompanying drawings that are provided. Furthermore, the apparatus may be shown in the form of a block diagram to avoid obscuring an understanding of the embodiments of the present disclosure, and the following fact is also taken into account: details regarding the implementation of the apparatus in the form of block diagram are highly dependent upon a platform on which the embodiments of the present disclosure are to be implemented (i.e., such details should be fully understood by those skilled in the art). Where the specific details (e.g., circuitry) are set forth to describe the exemplary embodiments of the present disclosure, it will be apparent to those skilled in the art that the embodiments of the present disclosure may be implemented without these specific details or with variations to these specific details. These descriptions should therefore be considered illustrative rather than limiting.

Although the present disclosure has been described with reference to the specific embodiments of the present disclosure, many substitutions, modifications, and variations of these embodiments will be apparent to those of ordinary skill in the art from the above description. For example, the discussed embodiments may be used for other memory architectures (e.g., a dynamic RAM (DRAM)).

The embodiments of the present disclosure are intended to cover all such substitutions, modifications, and variations that fall within the broad scope of the appended claims. Therefore, any omissions, modifications, equivalent substitutions, improvements etc. made within the spirit and principle of the embodiments of the present disclosure are intended to be included within the scope of protection of the present disclosure.

1. A chat information processing method, comprising:
receiving a first operation for a first chat, wherein the first operation is used to spread content in the first chat to outside of the first chat, and the first chat is set as a first type of chat; and
performing, for the first operation, a second operation that prevents the first operation.

2. The method according to claim 1, further comprising:
setting the first chat as the first type of chat in response to receiving a first configuration operation performed on the first chat by a first type of member of the first chat.

3. The method according to claim 2, wherein the first configuration operation comprises one or more of:
an operation of not allowing copying messages;
an operation of not allowing forwarding messages;
an operation of not allowing downloading files;
an operation of not allowing screenshotting; or
an operation of not allowing screen recording.

4. The method according to claim 2, further comprising:
sending, in the first chat, a first system message that is visible to all members in response to receiving the first configuration operation, wherein the first system message is used to prompt that the first chat is set as the first type of chat.

5. The method according to claim 1, further comprising:
sending, in the first chat, a second system message that is visible only to a new member in response to the new member joining the first chat, wherein the second system message is used to prompt that the first chat is set as the first type of chat.

6. The method according to claim 3, wherein the performing, for the first operation, the second operation that prevents the first operation comprises:
responding to the first operation in response to receiving the first operation for the first chat; and
generating a third system message based on operation information of the first operation and information about a member who performs the first operation, and sending the third system message to another member of the first chat.

7. The method according to claim 3, wherein the performing, for the first operation, the second operation that prevents the first operation comprises:
preventing execution of a first operation instruction for the first operation for the first chat in response to receiving the first operation instruction,
wherein the first operation instruction is generated using a shortcut key or third-party software.

8. The method according to claim 3, wherein the performing, for the first operation, the second operation that prevents the first operation comprises:
blocking or blurring the first chat and executing a second operation instruction for performing the first operation on the first chat in response to receiving the second operation instruction,
wherein the second operation instruction is generated using a shortcut key or third-party software.

9. The method according to claim 3, wherein the performing, for the first operation, the second operation that prevents the first operation comprises:
obtaining a first control in the first chat that is used to perform the first operation, and setting the first control to an inoperable state.

10. The method according to claim 9, further comprising:
displaying first prompt information at a first preset position of the first chat, wherein the first prompt information is used to prompt that the first operation is inoperable on the first chat,
wherein the first preset position is adjacent to a position of the first control in the first chat.

11. The method according to claim 3, wherein the method further comprises:
displaying, in a first list, a first message in the first chat in response to receiving a third operation for the first message; and
the performing, for the first operation, the second operation that prevents the first operation comprises: obtaining a second control in the first list that is used to perform the first operation on the first message, and setting the second control to an inoperable state.

12. The method according to claim 3, wherein the method further comprises:
displaying a picture management window in response to receiving a trigger operation for a picture file in the first chat; and
the performing, for the first operation, the second operation that prevents the first operation comprises: obtaining a third control in the picture management window that is used to perform the first operation on the picture file, and setting the third control to an inoperable state.

13. The method according to claim 1, further comprising:
setting the first chat as the first type of chat in response to a second configuration operation performed on the first chat by a first type of member of the first chat; and
in the first chat, responding to the first operation in response to receiving the first operation performed on the first chat by the first type of member.

14. The method according to claim 1, before the receiving of the first operation for the first chat, further comprising:
displaying a first window above the first chat; and
responding to the first operation for the first window and performing, for the first chat, the second operation that prevents the first operation in response to receiving the first operation for the first window.

15. The method according to claim 1, wherein the first operation comprises at least one of copying, forwarding, downloading, screenshotting, or screen recording.

16. (canceled)

17. An electronic device, comprising a memory, a processor, and a computer program stored on the memory and capable of running on the processor, wherein when the processor executes the program, a chat information processing method is implemented, the method comprising:
receiving a first operation for a first chat, wherein the first operation is used to spread content in the first chat to outside of the first chat, and the first chat is set as a first type of chat; and
performing, for the first operation, a second operation that prevents the first operation.

18. A non-transitory computer-readable storage medium storing computer instructions that are used to cause a computer to perform a chat information processing method, comprising:
receiving a first operation for a first chat, wherein the first operation is used to spread content in the first chat to outside of the first chat, and the first chat is set as a first type of chat; and
performing, for the first operation, a second operation that prevents the first operation.

19. (canceled)

20. The electronic device according to claim 17, wherein the method further comprises:
setting the first chat as the first type of chat in response to receiving a first configuration operation performed on the first chat by a first type of member of the first chat.

21. The electronic device according to claim 20, wherein the first configuration operation comprises one or more of:
an operation of not allowing copying messages;
an operation of not allowing forwarding messages;
an operation of not allowing downloading files;
an operation of not allowing screenshotting; or
an operation of not allowing screen recording.

22. The non-transitory computer-readable storage medium according to claim 18, wherein the method further comprises:
setting the first chat as the first type of chat in response to receiving a first configuration operation performed on the first chat by a first type of member of the first chat.
